(19) United States
(12) Patent Application Publication
(10) Pub. No.: US 2026/0259629 A1
(43) Pub. Date: Sep. 3, 2026

(54) PRESSURE TOUCH SENSING DEVICE HAVING IMPROVED STRUCTURE AND METHOD THEREOF

(71) Applicant: ABOV Semiconductor Co., Ltd., Cheongju-si (KR)

(72) Inventors: Youngjin SEO, Seoul (KR); Yoonki KIM, Seoul (KR); Dong Sik MIN, Suji-gu Gyeonggi-do (KR); Yeongjin MUN, Seoul (KR); Dong Geun YOU, Cheongju-si (KR); Seohan LEE, Seoul (KR)

(21) Appl. No.: 19/655,759

(22) Filed: Apr. 23, 2026

Related U.S. Application Data
(63) Continuation of application No. PCT/KR2024/017990, filed on Nov. 14, 2024.

(30) Foreign Application Priority Data
Nov. 21, 2023 (KR) 10-2023-0161746

(51) Int. Cl. G06F 3/041; G06F 3/044

(52) U.S. Cl. CPC G06F 3/0418; G06F 3/0414; G06F 3/044; G06F 2203/04101; G06F 2203/04107

(57) ABSTRACT

The present invention relates to a pressure touch sensing device having an improved structure and a pressure touch sensing method, and more particularly, to a pressure touch sensing device having an improved structure and a pressure touch sensing method that can prevent malfunction upon repeated and rapid application of pressure and due to reasons other than pressure.

### CROSS-REFERENCE TO RELATED APPLICATIONS

The is a bypass continuation of International PCT Application No. PCT/KR2024/017990, which claims priority to Republic of Korea Patent Application No. 10-2023-0161746 filed on November 21, 2023, which is incorporated by reference herein in its entirety.

### TECHNICAL FIELD

The present invention relates to a pressure touch sensing device with an improved structure and a pressure touch sensing method, and more particularly, to a pressure touch sensing device with an improved structure and a pressure touch sensing method that can prevent malfunction upon repeated and rapid application of pressure and due to reasons other than pressure.

### BACKGROUND ART

Referring to FIG. 1, a typical pressure sheet includes a plurality of conductive pads 11, 12, 13 stacked in different layers and a non-conductor 50 interposed between the conductive pads, and is affected by pressure through the conductive pads 12, 13, which sense the pressure when a hand touches the pressure sheet.

As shown in FIG. 2, a typical pressure sheet can equivalently represent two leakage problems: Ctl (touch leak, representing the capacitance induced by hand proximity) and Cml (mutual leak, representing the capacitance induced between multiple conductive pads and leaked to the hand). Ctl and Cml are not capacitance induced by pressure and can cause malfunction.

Ctl allows charge/discharge waveforms for capacitance measurement to be transferred from a sensor IC to the hand, leading to a significant increase in measured capacitance. This causes increase in measured data (raw data) by the effect of Ctl and increase in sensitivity even without pressure, which results in false determination.

In addition, Cml denotes the capacitance induced between the plurality of conductive pads for pressure measurement and leaking through the hand, which reduces the raw data by lowering the capacitance induced between the conductive pads. As a result, the measured data (raw data) decreases by Cml. In some cases, Cml exceeds the capacitance induced by pressure, rendering the applied pressure undetectable.

Here, Ctl (touch leak) refers to the capacitance formed by proximity of the hand, and Cml (mutual leak) refers to the capacitance formed by the plurality of conductive pads and leaking through the hand.

Referring to FIG. 3(a), when the hand approaches the sheet, Ctl (touch leak) causes an unintended increase in raw data, and when pressure is applied to the sheet, the raw data is represented by the sum of the capacitance formed by the pressure and Ctl. This makes it difficult to identify the cause of the increase in raw data.

Referring to FIG. 3(b) and FIG. 3(c), due to the effect of Cml (mutual leak), the capacitance between the plurality of conductive pads leaks through the hand, causing decrease in the measured capacitance. Referring to FIG. 3(c), when pressure is applied through a rapid hand touch as soon as the hand approaches the conductive pads, an increase in the raw data due to the pressure cannot be confirmed, thereby making it difficult to detect the pressure.

Referring to FIG. 3(d), the combination of Cml (mutual leak; capacitance leaking through the hand) and Ctl (touch leak; capacitance induced by proximity of the hand) results in a decrease in capacitance by Cml and an increase in capacitance by Ctl, thereby making it difficult to detect the pressure.

Therefore, in a typical pressure sheet stack diagram, additional software algorithms are required to solve the problems of raw data decreasing due to hand contact with the sheet or increasing due to application of pressure.

In other words, such a conventional technique suffers from several problems, such as memory waste or time loss due to additional algorithms, malfunction upon repeated and rapid application of pressure for processing due to hand contact, failure in pressure detection (similar to Cml = Ctl + Cforce), and malfunction caused by hand proximity even without applied pressure.

### SUMMARY

It is an object of the present invention to provide a pressure touch sensing device with an improved structure and a pressure touch sensing method that can eliminate hand-induced capacitance changes by adding a shield to a pressure sheet, and can distinguish pressure touches without additional software algorithms by changing a waveform sensing a conductive pad closest to the hand among a plurality of conductive pads for pressure measurement to static voltage mode, and can achieve accurate recognition of repeated and rapid pressure changes.

In accordance with one aspect of the present invention, a pressure touch sensing device with an improved structure includes: a sensor pad including a plurality of conductive pads stacked in different layers and a non-conductor interposed between the conductive pads; a shielding unit enclosing a side surface of the sensor pad to shield a mutual capacitance component induced between the conductive pads; and a sensor IC connected to the plurality of conductive pads of the sensor pad; wherein the sensor IC including: a first sensor configured to sense a capacitance between an innermost conductive pad and a conductive pad adjacently disposed on the innermost conductive pad among the plurality of conductive pads; a second sensor configured to sense a capacitance of an outermost conductive pad among the plurality of conductive pads; and a converter configured to convert at least one of the plurality of conductive pads to operate in static voltage mode or as a shielding region, wherein the sensor IC senses a pressure-induced capacitance change through the first sensor and a capacitance change due to external touch and proximity through the second sensor, and sets the shielding unit to operate in any one of ground (GND), shielding, and static voltage modes.

In accordance with another aspect of the present invention, a pressure touch sensing device with an improved structure includes: a sensor pad including a plurality of conductive pads stacked in different layers and a non-conductor interposed between the conductive pads; a shielding unit enclosing a side surface of the sensor pad and, optionally, an upper portion of the sensor pad depending on a target structure to shield a mutual capacitance component induced between the conductive pads; and a sensor IC connected to the plurality of conductive pads of the sensor pad; wherein the sensor IC including a first sensor configured to sense a capacitance between an innermost conductive pad and a conductive pad adjacently disposed on the innermost conductive pad among the plurality of conductive pads; and a converter configured to convert at least one of the plurality of conductive pads to operate in static voltage mode or as a shielding region, wherein the sensor IC senses a pressure-induced capacitance change through the first sensor and sets the shielding unit to operate in any one of ground (GND), shielding, and static voltage modes.

In the pressure touch sensing device, the shielding unit may be formed on a lower surface of the sensor pad depending on a condition of a target structure; and when the shielding unit is formed on the lower surface of the sensor pad, the sensor pad may further include a non-conductor disposed under the innermost conductive pad, and the shielding unit may be disposed on a lower surface of the non-conductor disposed under the innermost conductive pad to prevent the innermost conductive pad from experiencing a capacitance change due to disturbance.

In the pressure touch sensing device, upon sensing the innermost conductive pad among the plurality of conductive pads through the first sensor, the sensor IC may change the other conductive pads and the shielding unit to operate in any one of ground (GND), shielding, and static voltage modes to reduce sensitivity changes caused by external noise and touch.

In the pressure touch sensing device, upon sensing the outermost conductive pad among the plurality of conductive pads through the second sensor, the sensor IC sets a conductive pad disposed under the outermost conductive pad to operate in any one of shielding, ground (GND) and disconnection modes and sets the shielding unit to operate in any one of ground (GND), shielding, and static voltage modes to improve noise characteristics and sensitivity with respect to capacitance changes caused by external touch and proximity.

In the pressure touch sensing device, after pressure sensing, the sensor IC may sense the innermost conductive pad through the first sensor to detect capacitance changes due to environmental changes, and may set the other conductive pads and the shielding unit to operate in any one of ground (GND), shielding, and static voltage modes to reduce sensitivity changes caused by external noise and touch.

In the pressure touch sensing device, the outermost conductive pad may be disposed in a smaller area than an adjacent conductive pad; and the shielding unit may be formed to enclose the outermost conductive pad.

In the pressure touch sensing device, upon sensing a capacitance change due to external touch and proximity through the second sensor, the converter of the sensor IC may output in-phase waveforms to the shielding unit and a conductive pad other than the conductive pad sensed through the second sensor to prevent occurrence of a potential difference and malfunction due to conductive foreign matter.

In the pressure touch sensing device, upon sensing the outermost conductive pad among the plurality of conductive pads through the second sensor, the sensor IC may set the shielding unit to operate in any one of ground (GND), shielding, and static voltage modes to improve noise characteristics and sensitivity with respect to capacitance changes caused by external touch and proximity.

In accordance with a further aspect of the present invention, a pressure touch sensing method using a pressure touch sensing device with an improved structure, the pressure touch sensing device comprising: a sensor pad including a plurality of conductive pads stacked in different layers and a non-conductor interposed between the conductive pads; a shielding unit enclosing a side surface of the sensor pad to shield a mutual capacitance component induced between the conductive pads; and a sensor IC connected to the plurality of conductive pads of the sensor pad, the sensor IC including a first sensor configured to sense pressure, a second sensor configured to sense proximity and touch, and a converter configured to convert at least one of the plurality of conductive pads to operate in static voltage mode or as a shielding region, and setting the shielding unit to operate in any one of ground (GND), shielding, and static voltage modes, the pressure touch sensing method including; a first sensing step in which a capacitance between an innermost conductive pad and a conductive pad adjacently disposed on the innermost conductive pad among the plurality of conductive pads is sensed through the first sensor; and a second sensing step in which a capacitance of an outermost conductive pad among the plurality of conductive pads is sensed through the second sensor, wherein the sensor IC senses a pressure-induced capacitance change in the first sensing step and a capacitance change due to external touch and proximity in the second sensing step, and sets the shielding unit to operate in any one of ground (GND), shielding, and static voltage modes upon sensing in the first sensing step or the second sensing step.

In accordance with yet another aspect of the present invention, a pressure touch sensing method using a pressure touch sensing device with an improved structure, the pressure touch sensing device comprising: a sensor pad including a plurality of conductive pads stacked in different layers and a non-conductor interposed between the conductive pads; a shielding unit enclosing a side surface of the sensor pad and, optionally, an upper portion of the sensor pad depending on a target structure to shield a mutual capacitance component induced between the conductive pads; and a sensor IC connected to the plurality of conductive pads of the sensor pad, the sensor IC including a first sensor configured to sense pressure and a converter configured to convert at least one of the plurality of conductive pads to operate in static voltage mode or as a shielding region, and setting the shielding unit to operate in any one of ground (GND), shielding, and static voltage modes, the pressure touch sensing method including a first sensing step in which a capacitance between an innermost conductive pad and a conductive pad adjacently disposed on the innermost conductive pad among the plurality of conductive pads is sensed through the first sensor, wherein the sensor IC senses a pressure-induced capacitance change in the first sensing step and sets the shielding unit to operate in any one of ground (GND), shielding, and static voltage modes upon sensing in the first sensing step.

In the pressure touch sensing method, the shielding unit may be formed on a lower surface of the sensor pad depending on a target structure; and when the shielding unit is formed on the lower surface of the sensor pad, the sensor pad may further include a non-conductor disposed on a lower surface of the innermost conductive pad, and the shielding unit may be disposed on a lower surface of the non-conductor disposed on the lower surface of the innermost conductive pad and may be set to operate in any one of ground (GND), shielding, and static voltage modes in the shielding step to prevent the innermost conductive pad from experiencing a capacitance change due to disturbance.

In the pressure touch sensing method, upon sensing the innermost conductive pad among the plurality of conductive pads through the first sensor in the first sensing step, the sensor IC may set the other conductive pads and the shielding unit to operate in any one of ground (GND), shielding, and static voltage modes to reduce sensitivity changes caused by external noise and touch.

In the pressure touch sensing method, upon sensing the outermost conductive pad among the plurality of conductive pads through the second sensor in the second sensing step, the sensor IC may set a conductive pad disposed under the outermost conductive pad to operate in any one of shielding, ground (GND) and disconnection modes and may set the shielding unit to operate in any one of ground (GND), shielding, and static voltage modes to improve noise characteristics and sensitivity with respect to capacitance changes caused by external touch and proximity.

In the pressure touch sensing method, after pressure sensing, the sensor IC may sense the innermost conductive pad through the first sensor to detect a capacitance change due to an environmental change, and may set the other conductive pads and the shielding unit to operate in any one of ground (GND), shielding, and static voltage modes to reduce sensitivity changes caused by external noise and touch.

In the pressure touch sensing method, the outermost conductive pad may be disposed in a smaller area than other conductive pads adjacent thereto; and the shielding unit may be formed to enclose the outermost conductive pad disposed in a smaller area.

In the pressure touch sensing method, upon sensing a capacitance change due to external touch and proximity through the second sensor in the second sensing step, the converter of the sensor IC may output in-phase waveforms to the shielding unit and a conductive pad other than the conductive pad sensed through the second sensor to prevent occurrence of a potential difference and malfunction due to conductive foreign materials.

In the pressure touch sensing method, upon sensing the outermost conductive pad among the plurality of conductive pads through the second sensor in the second sensing step, the sensor IC may set the shielding unit to operate in any one of ground (GND), shielding, and static voltage modes to improve noise characteristics and sensitivity with respect to capacitance changes caused by external touch and proximity.

According to the present invention, the pressure touch sensing device and method can eliminate hand-induced capacitance changes by adding a shield to a pressure sheet, can distinguish pressure touches without additional software algorithms by changing a waveform sensing a conductive pad closest to the hand among a plurality of conductive pads for pressure measurement to static voltage mode, and can achieve accurate recognition of repeated and rapid pressure changes.

Furthermore, according to the present invention, the pressure touch sensing device and method can detect environmental influences through conductive pads without a separate sensor, thereby preventing malfunction due to environmental (temperature/humidity) changes while reducing manufacturing costs.

### BRIEF DESCRIPTION OF THE DRAWINGS

The accompanying drawings, which are included to provide a better understanding of the present invention, illustrate exemplary embodiments of the present invention together with the detailed description. However, it should be understood that the technical features of the invention are not limited to any particular drawing, and the features disclosed in each drawing may be combined with each other to form new embodiments.

FIG. 1 to FIG. 3 are views illustrating a pressure sheet structure of a typical pressure sensor and problems caused by mutual capacitance.

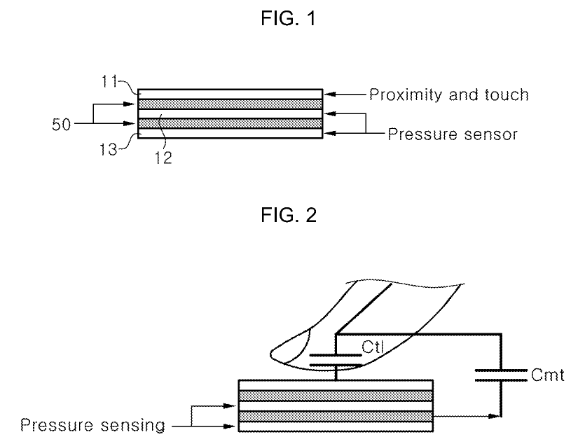

FIG. 4 and FIG. 5 are views schematically illustrating a pressure sheet including a sensor pad and a shielding unit of a pressure touch sensing device with an improved structure according to the present invention, and improved effects thereof.

FIG. 6 is a view illustrating that pressure is normally measured without data dropping through the pressure touch sensing device with an improved structure according to the present invention.

FIG. 7 is a view of the pressure touch sensing device with an improved structure according to the present invention.

FIG. 8 is a view of a pressure sheet according to a first embodiment in the pressure touch sensing device with an improved structure according to the present invention.

FIG. 9 and FIG. 10 are views of a pressure sheet according to a second embodiment in the pressure touch sensing device with an improved structure according to the present invention.

FIG. 11 and FIG. 12 are views of a pressure sheet according to a third embodiment in the pressure touch sensing device with an improved structure according to the present invention.

FIG. 13 is a flowchart illustrating a pressure touch detecting method according to the first embodiment shown in FIG. 8.

FIG. 14 shows a first embodiment illustrating the state of a conductive pad sensed over time in the pressure touch sensing method according to the present invention.

FIG. 15 is a flowchart illustrating a pressure touch sensing method according to the second embodiment shown in FIG. 9 and FIG. 10.

FIG. 16 shows a second embodiment illustrating the state of a conductive pad sensed over time in the pressure touch sensing method according to the present invention.

FIG. 17 is a flowchart illustrating a pressure touch sensing method according to the third embodiment shown in FIG. 11 and FIG. 12.

FIG. 18 shows a third embodiment illustrating the state of a conductive pad sensed over time in the pressure touch sensing method according to the present invention.

### DETAILED DESCRIPTION

Hereinafter, exemplary embodiments of the present invention will be described in detail with reference to the accompanying drawings.

The advantages, features, and aspects of the present invention will become apparent from the following description of embodiments given in conjunction with the accompanying drawings.

However, it should be understood that the present invention is not limited to the following embodiments and may be embodied in different ways. The following embodiments are provided for complete disclosure and thorough understanding of the invention by those skilled in the art, and the present invention will be defined by the appended claims.

In addition, descriptions of known functions and constructions which may unnecessarily obscure the subject matter of the invention will be omitted.

The features disclosed in each drawing may be combined with each other to form new embodiments.

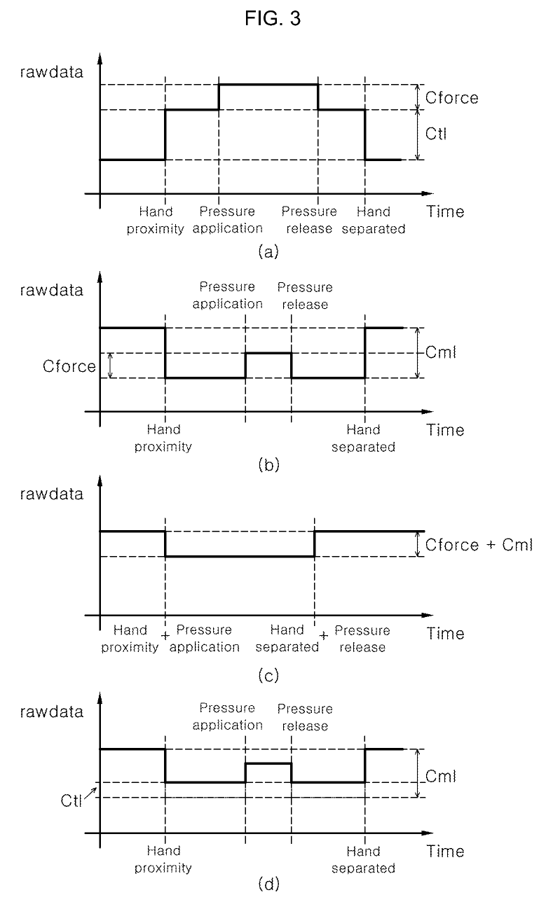

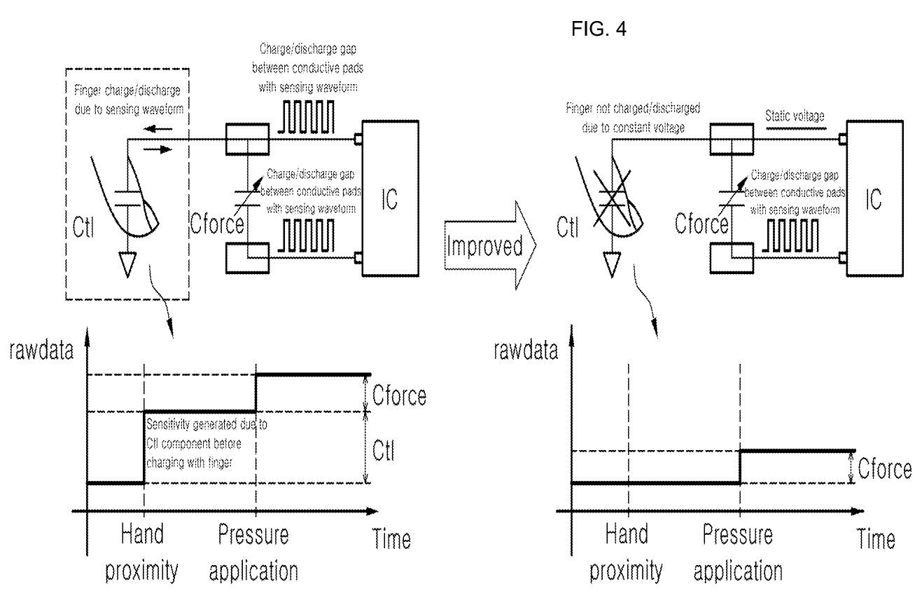

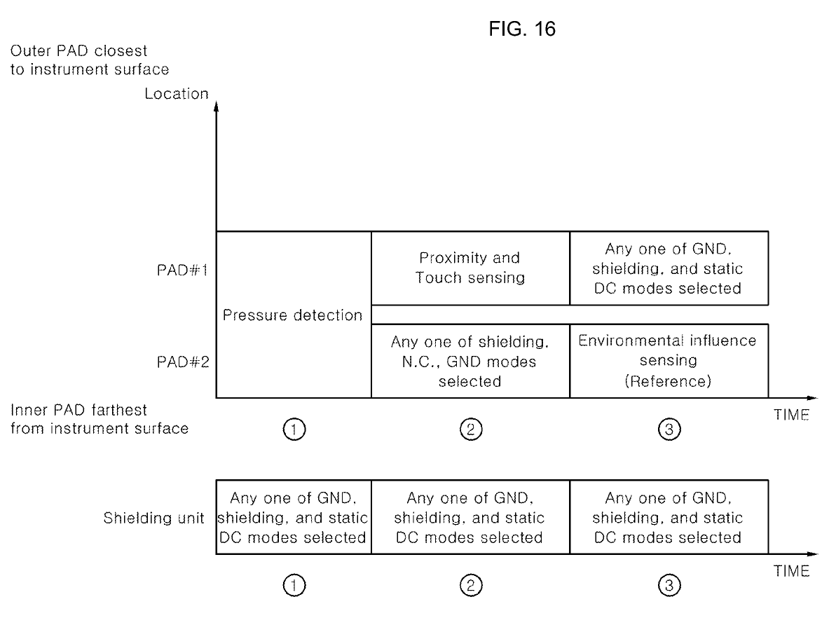

Referring to FIG. 4 to FIG. 18, a pressure touch sensing device with an improved structure and a pressure touch sensing method according to the present invention may employ a plurality of conductive pads to accurately detect a pressure touch.

When a hand touches a typical pressure sheet, a capacitance is induced between a pressure-sensing pad (PAD) and the hand, causing the pressure data (raw data) measured by a sensor IC to decrease by Cml (mutual leak).

In addition, the charge/discharge waveforms used for measuring capacitance are transferred to the hand, thereby causing the pressure data measured by the sensor IC to increase by Ctl (touch leak).

Referring to FIG. 4 to FIG. 6, in order to solve such problems, a pressure touch sensing device with an improved structure according to the present invention includes a shielding unit enclosing a side surface of the sensor pad to shield a mutual capacitance component induced between conductive pads and can eliminate Ctl by adopting a different sensing method.

Further, in the pressure touch sensing device, an outer conductive pad is set to a static (DC) voltage mode instead of a driving pulse mode. This structure eliminates charge transfer to the IC through the finger, thereby preventing the formation of Ctl.

As such, the pressure touch sensing device eliminates Cml through the shielding unit and prevents the formation of Ctl by changing the waveform sensing a conductive pad closest to the hand among a plurality of conductive pads used for pressure measurement to the static voltage mode.

As a result, the pressure touch sensing device enables pressure touch discrimination without additional software algorithms, thereby eliminating the possibility of memory waste or malfunction due to the algorithms while achieving accurate recognition of repeated and rapid pressure changes.

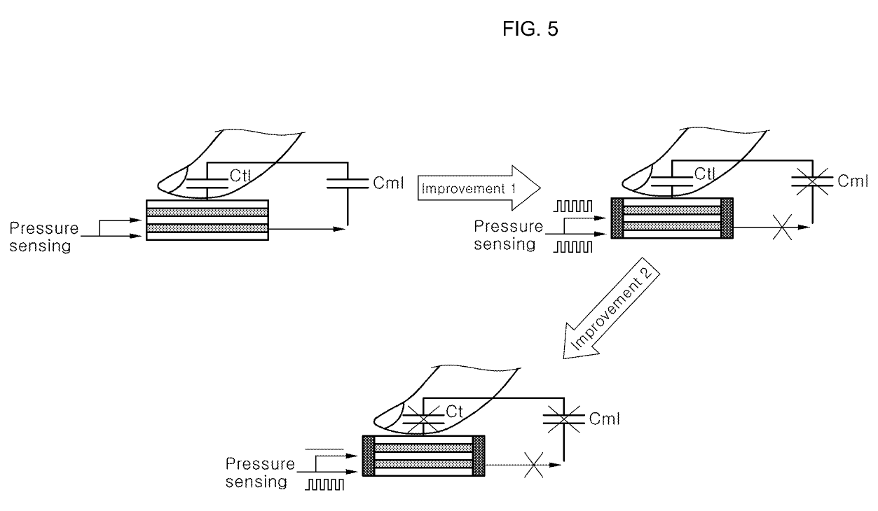

Referring to FIG. 7, the pressure touch sensing device according to the present invention may include: a sensor pad 100 including a plurality of conductive pads 111, 112 stacked in different layers and a non-conductor 50 interposed between the conductive pads 111, 112; a shielding unit 120 enclosing a side surface of the sensor pad 100 to shield a mutual capacitance component induced between the conductive pads from leaking; and a sensor IC 200 connected to the plurality of conductive pads in the sensor pad 100.

The sensor IC 200 may include: a first sensor 210 configured to sense a capacitance between an innermost conductive pad 112 and a conductive pad adjacently disposed on the innermost conductive pad 112 among the plurality of conductive pads 111, 112; a second sensor 220 configured to sense a capacitance of an outermost conductive pad 111 among the plurality of conductive pads; and a converter 250 configured to convert at least one of the plurality of conductive pads to operate in static voltage mode or as a shielding region.

The sensor IC 200 may sense a pressure-induced capacitance change through the first sensor 210 and a capacitance change due to external touch and proximity through the second sensor 220, and may set the shielding unit 120 to operate in any one of ground (GND), shielding, and static voltage modes.

In some cases where two conductive pads are stacked, among the plurality of conductive pads stacked one above another, a first conductive pad 111 closest to a surface of an instrument may be referred to as an outer pad and a second conductive pad 112 farthest from the surface of the instrument may be referred to as an inner pad.

In addition, in some cases where three conductive pads 111, 112, 113 are provided, the first to third conductive pads 111, 112, 113 may be connected to the ground (GND), the first sensor 210, the second sensor 220, or the converter 250.

In the sensor IC 200, the first sensor 210 may sense the capacitance between the conductive pads in a differential manner, and the second sensor 220 is a self-sensing type sensor and may sense whether the conductive pads are touched.

That is, the first sensor 210 may sense a pressure touch through comparison of a difference in capacitance by sensing the capacitance between the first conductive pad 111 and the second conductive pad 112, and the second sensor 220 may sense proximity and touch of the first conductive pad 111.

Further, the pressure change may be sensed through the first sensor 210 and then the proximity and touch may be sensed through the second sensor 220. Alternatively, the proximity and touch may be sensed through the second sensor 220 and then the pressure change may be sensed through the first sensor 210.

In other words, regardless of the sensing order of the first sensor 210 and the second sensor 220, an increase in sensitivity of both the first sensor 210 and the second sensor 220 may be determined as a touch by the hand.

Accordingly, an increase in sensitivity of only one of the two sensors may be determined as a touch caused by foreign matter rather than a touch caused by the hand, thereby preventing the occurrence of malfunction.

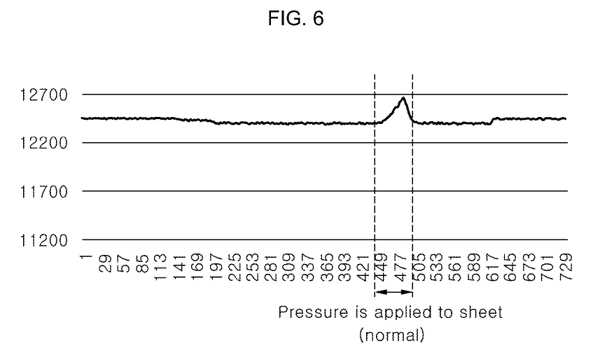

Further, as shown in FIG. 8(a), in the pressure touch sensing device with the improved structure, the sensor pad 100 according to the first embodiment may include a plurality of conductive pads 111, 112 stacked in different layers and a non-conductor 50 disposed on each of the conductive pads 111, 112.

In addition, the shielding unit 120 may enclose upper and side surfaces of the sensor pad 100 to shield a mutual capacitance component induced between the conductive pads.

Further, the sensor IC 200 may be connected to the plurality of conductive pads in the sensor pad and may detect a pressure-induced capacitance change by sensing the capacitance between the innermost conductive pad 112 and the conductive pad 111 adjacently disposed on the innermost conductive pad 112 among the plurality of conductive pads through the first sensor 210.

In addition, as shown in FIG. 8(b), depending on a target structure (to which the pressure touch sensing device is applied), the shielding unit 120 may also be formed on a lower surface of the sensor pad 100.

That is, in the structure that the shielding unit 120 is also formed on the lower surface of the sensor pad 100, the sensor pad 100 may further include a non-conductor 50 disposed on a lower surface of the innermost conductive pad 112 and the shielding unit 120 is formed on a lower surface of the non-conductor 50 to prevent the innermost conductive pad 112 from experiencing a capacitance change due to disturbance.

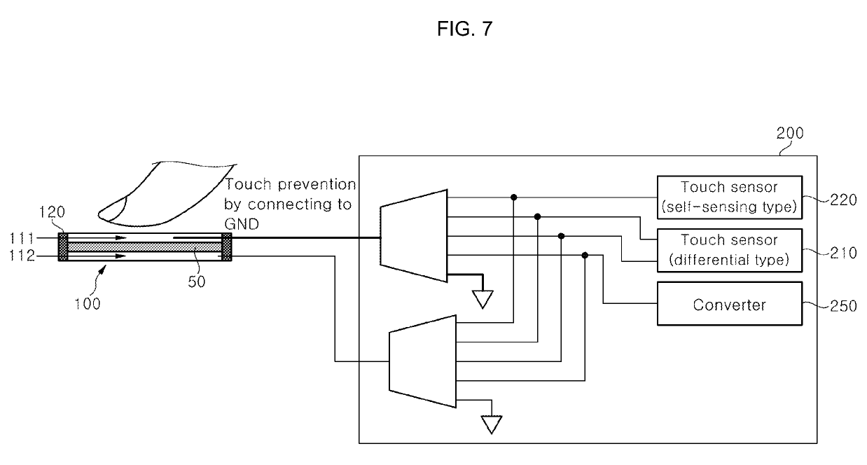

In addition, referring to FIG. 9 and FIG. 10, among the plurality of conductive pads, the outermost conductive pad 111 may be disposed in the same area as the adjacent conductive pad 112, as shown in FIG. 9. Alternatively, as shown in FIG. 10, the outermost conductive pad 111 may be disposed in a smaller area than the adjacent conductive pad 112.

Furthermore, the shielding unit 120 may enclose the side surface of the outermost conductive pad 111 among the plurality of conductive pads and may also enclose the upper surface thereof depending on a target structure.

That is, the shielding unit 120 may enclose the outermost conductive pad 111 such that a capacitance change caused by external touch and proximity can be sensed through the outermost conductive pad 111.

Furthermore, when three conductive pads are used, the second conductive pad 112 and the third conductive pad 113 may be used as pressure sensors, and the first conductive pad 111 may be used as a proximity and touch detection sensor.

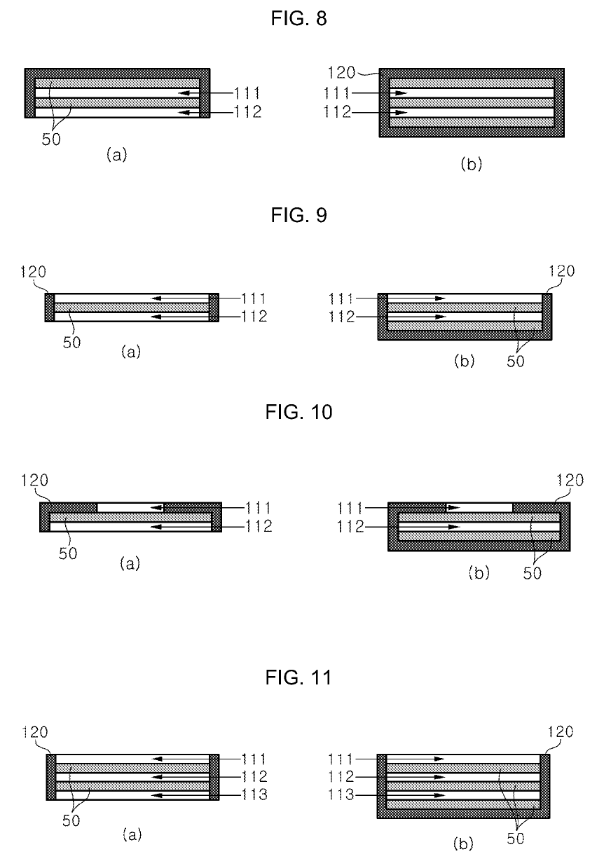

For example, referring to FIG. 11 and FIG. 12, while the first conductive pad 111 senses proximity and touch through the second sensor 220, the second conductive pad 112 is connected to the converter 250 to represent a state in which the first conductive pad 111 and the second conductive pad 112 have in-phase waveforms that overlap, resulting in increased sensing sensitivity.

Obviously, the third conductive pad 113 may also be connected to the converter 250 to further increase the sensing sensitivity.

That is, when the second sensor 220 senses a capacitance change due to external touch and proximity, the converter 250 of the sensor IC 200 outputs in-phase waveforms to the shielding unit and the conductive pads other than the conductive pad sensed through the second sensor 220 to eliminate potential differences, thereby preventing malfunction due to conductive foreign matter.

In addition, upon sensing the innermost conductive pad among the plurality of conductive pads through the first sensor 210, the sensor IC 200 may change the other conductive pads and the shielding unit to connect to the ground (GND) to reduce sensitivity changes caused by external noise and touch.

Furthermore, by connecting the conductive pads 112, 113 other than the first conductive pad 111 sensed through the second sensor 220 to the ground (GND), the pressure touch sensing device can prevent transfer of noise induced in the second conductive pad 112 to the first conductive pad 111.

Furthermore, when sensing through the first sensor 210 and the second sensor 220, a conductive pad other than the conductive pad sensed therethrough may be connected to the converter in the following three ways.
1 When a conductive pad other than the conductive pad sensed through the first or second sensor is connected to the converter, the waveform of the sensed conductive pad overlaps in-phase with the waveform of the conductive pad located under the sensed conductive pad, thereby improving sensing sensitivity.
2 When a conductive pad other than the conductive pad sensed through the first or second sensor is not connected to the converter, it is possible to improve sensing sensitivity, despite failure in protecting against noise induced by the conductive pad sensed therethrough.
3 When a conductive pad other than the conductive pad sensed through the first or second sensor is connected to the ground (GND), it is possible to protect against noise induced by the conductive pad sensed therethrough.

In other words, depending on sensing sensitivity and environments, the conductive pad other than the conductive pad sensed through the first or second sensor may not be connected to the converter, may be connected to the converter to further improve the sensing sensitivity, or may be connected to the ground (GND) to protect against noise.

That is, upon sensing the outermost conductive pad 111 among the plurality of conductive pads through the second sensor 220, the sensor IC 200 may set the conductive pads 112, 113 located below the outermost conductive pad 111 to operate in any one of shielding, ground (GND), or disconnection mode, and may set the shielding unit 120 to operate in shielding or ground (GND) mode, thereby improving noise characteristics and sensitivity with respect to capacitance changes caused by external touch and proximity.

In addition, upon sensing the outermost conductive pad 111 among the plurality of conductive pads through the second sensor 220, the sensor IC 200 may set the shielding unit 120 to operate in shielding or ground (GND) mode, thereby improving noise characteristics and sensitivity with respect to capacitance changes caused by external touch and proximity.

Further, in some cases where a third conductive pad 113 is provided, after pressure sensing, the sensor IC 200 may sense the innermost conductive pad 113 through the first sensor 210 to detect a capacitance change due to an environmental change, and may set the other conductive pads 111,112 and the shielding unit 120 to operate in any one of ground (GND), shielding, and static voltage modes to reduce sensitivity changes caused by external noise and touch.

As a result, it is possible to solve malfunction caused by physical changes in capacitor characteristics upon change in environmental (temperature/humidity) condition.

In such cases, the outer conductive pad 111 closest to the surface of the instrument may be set to operate in any one of ground (GND), shielding, and static voltage modes to block sensitivity with respect to external noise and touch, and the inner conductive pad 113 may be sensed as a reference channel to check a value changed by an environmental factor (temperature/humidity).

In such cases, the third conductive pad 113, which is the inner conductive pad, may be used as a reference channel to respond to environmental changes.

In this structure, a conductive pad for measuring pressure is used without a typical separate sensor, thereby ensuring cost effectiveness.

As described above, in the first embodiment, despite difficulty in proximity sensing, the pressure touch sensing device does not form Cml upon shielding in any one mode selected from among the ground (GND), shielding, and static voltage modes, and prevents generation of Ctl induced by the hand through improvement of the sensing waveform, thereby making it possible to determine based only on the pressure.

In addition, in the second embodiment in which the outer conductive pad touched by the hand is exposed, despite vulnerability to external noise, the pressure touch sensing device does not form Ctl through improvement of the sensing waveform, has the most cost-effective structure (requires fewer sheet layers), and also enables proximity sensing to determine accurate motion.

Furthermore, in the third embodiment, despite the largest amount of material for the sheet layers, the pressure touch sensing device does not form Cml upon shielding in any one mode selected from among the ground (GND), shielding and static voltage modes, suppresses noise generation by shielding the outer conductive pad upon pressure measurement, enables proximity sensing to determine accurate motion, and prevents generation of Ctl induced by the hand through improvement of the sensing waveform, thereby making it possible to determine based only on the pressure.

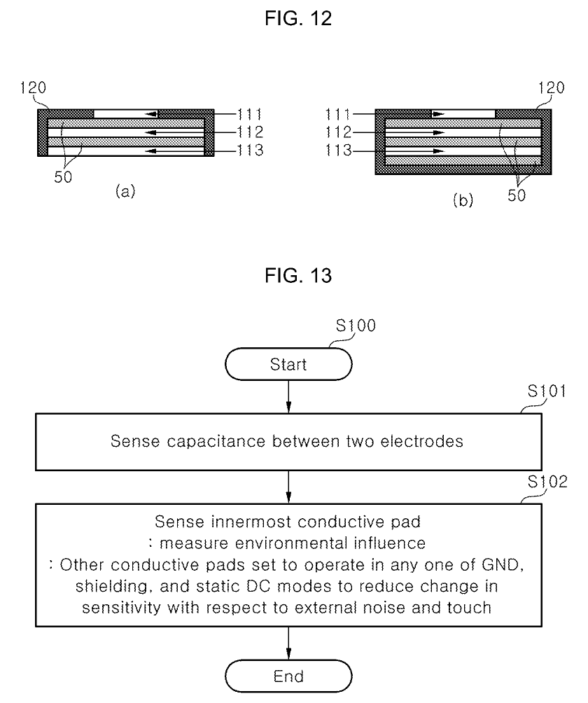

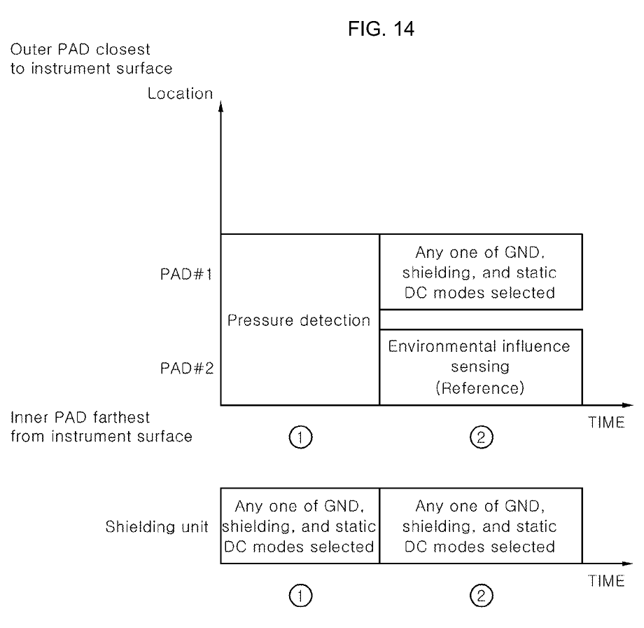

Further, a pressure touch sensing method according to another aspect of the present invention will be described with reference to FIG. 13 and FIG. 14. In this method, a pressure touch sensing device includes: a sensor pad 100 including a plurality of conductive pads 111, 112 stacked in different layers and a non-conductor 50 disposed on an upper surface of each of the conductive pads; a shielding unit 120 enclosing upper and side surfaces of the sensor pad 100 to shield a mutual capacitance component induced between the conductive pads; and a sensor IC 200 connected to the plurality of conductive pads of the sensor pad 100 and including a first sensor 210 configured to sense pressure, and a converter 250 configured to convert the conductive pads to operate in static voltage mode or as a shielding region, wherein the shielding unit 120 is set to operate in any one of ground (GND), shielding, and static voltage modes. The pressure touch sensing method includes: a first sensing step S101 in which a capacitance between an innermost conductive pad 112 and a conductive pad 111 adjacently disposed on the innermost conductive pad 112 among the plurality of conductive pads is sensed through the first sensor 210, wherein the sensor IC 200 may sense a pressure-induced capacitance change in the first sensing step S101 and may set the shielding unit 120 to operate in any one of ground (GND), shielding, and static voltage modes upon sensing in the first sensing step S101.

Furthermore, after pressure sensing in the first sensing step S101, the sensor IC 200 may sense the innermost conductive pad through the first sensor 210 to detect a capacitance change due to an environmental change (S102), and the other conductive pads and the shielding unit may be set to operate in any one of ground (GND), shielding, and static voltage modes to reduce sensitivity changes caused by external noise and touch.

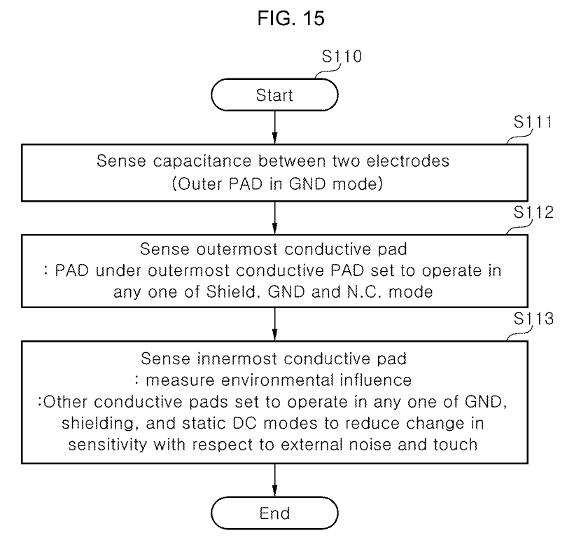

Further, a pressure touch sensing method according to another aspect of the present invention will be described with reference to FIG. 15 to FIG. 18. In this method, a pressure touch sensing device includes: a sensor pad 100 including a plurality of conductive pads 111, 112, 113 stacked in different layers and a non-conductor 50 interposed between the conductive pads; a shielding unit 120 enclosing upper and side surfaces of the sensor pad 100 to shield a mutual capacitance component induced between the conductive pads; and a sensor IC 200 connected to the plurality of conductive pads of the sensor pad 100 and including a first sensor 210 configured to sense pressure, a second sensor 220 configured to sense proximity and touch, and a converter 250 configured to convert at least one of the conductive pads to operate in static voltage mode or as a shielding region, and controlling connection of the shielding unit 120 to the ground (GND).

The sensing method includes: a first sensing step S111 in which a capacitance between an innermost conductive pad 113 and a conductive pad 112 adjacently disposed on the innermost conductive pad 113 among the plurality of conductive pads 111, 112, 113 is sensed through the first sensor 210 of the sensor IC 200; and a second sensing step S112 in which a capacitance of an outermost conductive pad 111 is sensed through a second sensor 220 of the sensor IC 200.

In addition, the sensor IC 200 may sense a pressure-induced capacitance change in the first sensing step S111 and a capacitance change due to external touch and proximity in the second sensing step S112, and may set the shielding unit to operate in any one of ground (GND), shielding, and static voltage modes upon sensing in the first sensing step or the second sensing step.

Furthermore, after pressure sensing or proximity and touch sensing, the innermost conductive pad 113 among the plurality of conductive pads may be sensed and a capacitance change due to an environmental change may be detected (S113), and the other conductive pads and the shielding unit are set to operate in any one of ground (GND), shielding, and static voltage modes to reduce sensitivity changes caused by external noise and touch.

Furthermore, in the second sensing step S112, the conductive pads 112, 113 under the outermost conductive pad 111 may be set to operate in any one of shielding, ground (GND), and disconnection modes, and the shielding unit may be set to operate in any one of ground (GND), shielding, and static voltage modes to adjust sensitivity with respect to capacitance changes caused by external touch and proximity.

Furthermore, in the second sensing step S112, upon sensing the outermost conductive pad among the plurality of conductive pads through the second sensor 220, the sensor IC 200 may set the shielding unit 120 to operate in ground (GND) or shielding mode, or may set the shielding unit to operate in any one of ground (GND), shielding, and static voltage modes to improve noise characteristics and sensitivity with respect to capacitance changes caused by external touch and proximity.

Furthermore, in the step S113 of sensing a capacitance change due to an environmental change, upon sensing the innermost conductive pad 113, the other conductive pads 111, 112 and the shielding unit 120 may be set to operate in any one of ground (GND), shielding, and static voltage modes to reduce sensitivity changes caused by external noise and touch.

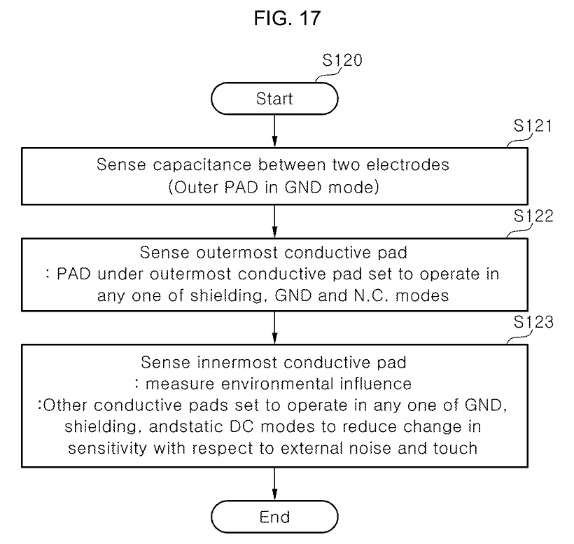

Referring to FIG. 17, in the first sensing step S121, upon sensing the innermost conductive pad 113 among the plurality of conductive pads through the first sensor 210, the sensor IC 200 may set the other conductive pads 111, 112 to operate in ground (GND) mode to reduce sensitivity changes caused by external noise and touch.

Further, in the second sensing step S122, upon sensing the outermost conductive pad among the plurality of conductive pads through the second sensor 220, the sensor IC 200 may set the conductive pads 112 and 113 under the outermost conductive pad 111 to operate in any one of shielding, ground (GND), and disconnection modes while setting the shielding unit to operate in any one of ground (GND), shielding, and static voltage modes to improve noise characteristics and sensitivity with respect to capacitance changes caused by external touch and proximity.

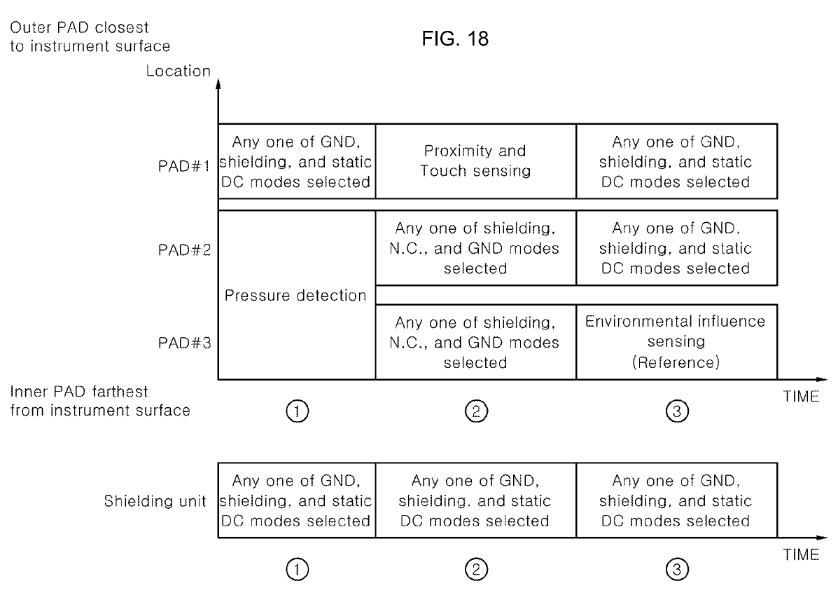

Furthermore, as shown in FIG. 18, sensing items in the flowchart may be determined in any order, and pressure information may be obtained with any combination of PAD #1, PAD #2, and PAD #3 in addition to a combination of conductive pads PAD #1 and PAD #2, or a combination of PAD #1 and PAD #3.

That is, a capacitance between the third conductive pad 113 located in the innermost layer for pressure detection and the second conductive pad 112 adjacent thereto is sensed. Here, the first conductive pad 111 located in the outermost layer may be set to operate in any one of ground (GND), shielding, and static voltage modes.

Furthermore, upon proximity and touch sensing through the first conductive pad 111, the second and third conductive pads 112, 113, which are conductive pads other than the first conductive pad that is sensed, may be set to operate in any one of shielding, disconnection, and ground (GND) modes.

Any one of these three modes may be selected to adjust sensing sensitivity depending on a sensing environment.

Here, the shielding unit 120 may operate in any one of ground (GND), shielding, and static voltage modes.

In this way, any of the three conditions may be selected to block disturbances.

In addition, in some cases where a third conductive pad 113 is provided, the third conductive pad 113 located in the innermost layer may be used as a reference channel to sense environmental influences, the first conductive pad 111 located in the outermost layer may be set to operate in any one of ground (GND), shielding, and static voltage modes, and the second conductive pad 112 may be set to operate in any one of ground (GND), shielding, and static voltage modes.

In such cases, the third conductive pad 113 located in the innermost layer is used to sense capacitance to detect environmental influences.

Then, upon proximity and touch sensing through the first conductive pad 111, the second conductive pad 112, which is a conductive pad other than the first conductive pad 111 that is sensed, may be set to operate in any one of shielding, disconnection, and ground (GND) modes.

Any one of these three conditions may be selected to adjust sensing sensitivity depending on a sensing environment.

Here, the shielding unit 120 may operate in any one of ground (GND), shielding, and static voltage modes to block external noise.

Furthermore, in the sensor pad 100, the outermost conductive pad 111 of the plurality of conductive pads may be disposed in a smaller area than the other conductive pads adjacent thereto 112, and the shielding unit 120 may enclose an upper portion of the outermost conductive pad 111 among the plurality of conductive pads.

Therefore, according to the present invention, the pressure touch sensing device and method eliminate hand-induced capacitance changes by adding a shield to a pressure sheet to operate in any one of ground (GND), shielding, and static voltage modes, distinguishes pressure touches without additional software algorithms by setting the waveform sensing the conductive pad closest to the hand among the plurality of conductive pads for pressure measurement to static voltage mode, and achieve accurate recognition of repeated and rapid pressure changes.

Furthermore, according to the present invention, the pressure touch sensing device and method can detect environmental influences through conductive pads without a separate sensor, thereby preventing malfunction due to environmental (temperature/humidity) changes while reducing manufacturing costs.

Although some exemplary embodiments have been described with reference to the accompanying drawings, it should be understood that various modifications and changes can be made by those skilled in the art without departing from the spirit and scope of the invention.

Therefore, the scope of the invention should not be limited to the embodiments described herein, but should be defined by the appended claims and equivalents thereto.

In other words, the foregoing embodiments are to be considered in all respects as illustrative and not restrictive. The scope of the invention is defined by the appended claims rather than the detailed description, and all variations and modifications within the meaning and scope of the claims and equivalents thereto are to be construed as being included within the scope of the invention.

### List of Reference Numerals

50: Non-conductor

100: Sensor pad

111: First conductive pad

112: Second conductive pad

113: Third conductive pad

120: Ground (GND) Shielding unit

200: Sensor IC

210: First sensor (differential method)

220: Second sensor (self-sensing type)

250: Converter

What is claimed is:

1. A pressure touch sensing device with an improved structure, comprising:
a sensor pad comprising a plurality of conductive pads stacked in different layers and a non-conductor interposed between the conductive pads;
a shielding unit enclosing a side surface of the sensor pad to shield a mutual capacitance component induced between the conductive pads; and
a sensor IC connected to the plurality of conductive pads of the sensor pad;
wherein the sensor IC comprises a first sensor configured to sense a capacitance between an innermost conductive pad and a conductive pad adjacently disposed on the innermost conductive pad among the plurality of conductive pads, a second sensor configured to sense a capacitance of an outermost conductive pad among the plurality of conductive pads; and a converter configured to convert at least one of the plurality of conductive pads to operate in static voltage mode or as a shielding region,
wherein the sensor IC senses a pressure-induced capacitance change through the first sensor and a capacitance change due to external touch and proximity through the second sensor, and sets the shielding unit to operate in any one of ground (GND), shielding, and static voltage modes.

2. A pressure touch sensing device with an improved structure, comprising:
a sensor pad comprising a plurality of conductive pads stacked in different layers and a non-conductor interposed between the conductive pads;
a shielding unit enclosing a side surface of the sensor pad and, optionally, an upper portion of the sensor pad depending on a target structure to shield a mutual capacitance component induced between the conductive pads; and
a sensor IC connected to the plurality of conductive pads of the sensor pad;
wherein the sensor IC comprises a first sensor configured to sense a capacitance between an innermost conductive pad and a conductive pad adjacently disposed on the innermost conductive pad among the plurality of conductive pads, and a converter configured to convert at least one of the plurality of conductive pads to operate in static voltage mode or as a shielding region,
wherein the sensor IC senses a pressure-induced capacitance change through the first sensor and sets the shielding unit to operate in any one of ground (GND), shielding, and static voltage modes.

3. The pressure touch sensing device according to claim 1, wherein the shielding unit is formed on a lower surface of the sensor pad depending on a condition of a target structure; and
when the shielding unit is formed on the lower surface of the sensor pad, the sensor pad further comprises a non-conductor disposed under the innermost conductive pad, and
the shielding unit is disposed on a lower surface of the non-conductor disposed under the innermost conductive pad to prevent the innermost conductive pad from experiencing a capacitance change due to disturbance.

4. The pressure touch sensing device according to claim 2, wherein the shielding unit is formed on a lower surface of the sensor pad depending on a condition of a target structure; and
when the shielding unit is formed on the lower surface of the sensor pad, the sensor pad further comprises a non-conductor disposed under the innermost conductive pad, and
the shielding unit is disposed on a lower surface of the non-conductor disposed under the innermost conductive pad to prevent the innermost conductive pad from experiencing a capacitance change due to disturbance.

5. The pressure touch sensing device according to claim 1, wherein, upon sensing the innermost conductive pad among the plurality of conductive pads through the first sensor, the sensor IC sets the other conductive pads and the shielding unit to operate in any one of ground (GND), shielding, and static voltage modes to reduce sensitivity changes caused by external noise and touch.

6. The pressure touch sensing device according to claim 1, wherein, upon sensing the outermost conductive pad among the plurality of conductive pads through the second sensor, the sensor IC sets a conductive pad disposed under the outermost conductive pad to operate in any one of shielding, ground (GND) and disconnection modes and sets the shielding unit to operate in any one of ground (GND), shielding, and static voltage modes to improve noise characteristics and sensitivity with respect to capacitance changes caused by external touch and proximity.

7. The pressure touch sensing device according to claim 1, wherein, after pressure sensing, the sensor IC senses the innermost conductive pad through the first sensor to detect capacitance changes due to environmental changes, and sets the other conductive pads and the shielding unit to operate in any one of ground (GND), shielding, and static voltage modes to reduce sensitivity changes caused by external noise and touch.

8. The pressure touch sensing device according to claim 1, wherein
the outermost conductive pad is disposed in a smaller area than an adjacent conductive pad; and
the shielding unit is formed to enclose the outermost conductive pad.

9. The pressure touch sensing device according to claim 1, wherein, upon sensing a capacitance change due to external touch and proximity through the second sensor, the converter of the sensor IC outputs in-phase waveforms to the shielding unit and a conductive pad other than the conductive pad sensed through the second sensor to prevent occurrence of a potential difference and malfunction due to conductive foreign matter.

10. The pressure touch sensing device according to claim 1, wherein, upon sensing the outermost conductive pad among the plurality of conductive pads through the second sensor, the sensor IC sets the shielding unit to operate in any one of ground (GND), shielding, and static voltage modes to improve noise characteristics and sensitivity with respect to capacitance changes caused by external touch and proximity.

11. A pressure touch sensing method using a pressure touch sensing device with an improved structure, the pressure touch sensing device comprising: a sensor pad comprising a plurality of conductive pads stacked in different layers and a non-conductor interposed between the conductive pads; a shielding unit enclosing a side surface of the sensor pad to shield a mutual capacitance component induced between the conductive pads; and a sensor IC connected to the plurality of conductive pads of the sensor pad,
the sensor IC comprising a first sensor configured to sense pressure, a second sensor configured to sense proximity and touch, and a converter configured to convert at least one of the plurality of conductive pads to operate in static voltage mode or as a shielding region, the sensor IC setting the shielding unit to operate in any one of ground (GND), shielding, and static voltage modes,
the pressure touch sensing method comprising:
a first sensing step in which a capacitance between an innermost conductive pad and a conductive pad adjacently disposed on the innermost conductive pad among the plurality of conductive pads is sensed through the first sensor; and
a second sensing step in which a capacitance of an outermost conductive pad among the plurality of conductive pads is sensed through the second sensor,
wherein the sensor IC senses a pressure-induced capacitance change in the first sensing step and a capacitance change due to external touch and proximity in the second sensing step, and sets the shielding unit to operate in any one of ground (GND), shielding, and static voltage modes upon sensing in the first sensing step or the second sensing step.

12. A pressure touch sensing method using a pressure touch sensing device with an improved structure, the pressure touch sensing device comprising: a sensor pad comprising a plurality of conductive pads stacked in different layers and a non-conductor interposed between the conductive pads; a shielding unit enclosing a side surface of the sensor pad and, optionally, an upper portion of the sensor pad depending on a target structure to shield a mutual capacitance component induced between the conductive pads; and a sensor IC connected to the plurality of conductive pads of the sensor pad,
the sensor IC comprising a first sensor configured to sense pressure and a converter configured to convert at least one of the plurality of conductive pads to operate in static voltage mode or as a shielding region, the sensor IC setting the shielding unit to operate in any one of ground (GND), shielding, and static voltage modes,
the pressure touch sensing method comprising:
a first sensing step in which a capacitance between an innermost conductive pad and a conductive pad adjacently disposed on the innermost conductive pad among the plurality of conductive pads is sensed through the first sensor,
wherein the sensor IC senses a pressure-induced capacitance change in the first sensing step and sets the shielding unit to operate in any one of ground (GND), shielding, and static voltage modes upon sensing in the first sensing step.

13. The pressure touch sensing method according to claim 11, wherein the shielding unit is formed on a lower surface of the sensor pad depending on a target structure; and
when the shielding unit is formed on the lower surface of the sensor pad, the sensor pad further comprises a non-conductor disposed on a lower surface of the innermost conductive pad, and
the shielding unit is disposed on a lower surface of the non-conductor disposed on the lower surface of the innermost conductive pad and is set to operate in any one of ground (GND), shielding, and static voltage modes to prevent the innermost conductive pad from experiencing a capacitance change due to disturbance.

14. The pressure touch sensing method according to claim 12, wherein the shielding unit is formed on a lower surface of the sensor pad depending on a target structure; and
when the shielding unit is formed on the lower surface of the sensor pad, the sensor pad further comprises a non-conductor disposed on a lower surface of the innermost conductive pad, and
the shielding unit is disposed on a lower surface of the non-conductor disposed on the lower surface of the innermost conductive pad and is set to operate in any one of ground (GND), shielding, and static voltage modes to prevent the innermost conductive pad from experiencing a capacitance change due to disturbance.

15. The pressure touch sensing method according to claim 11, wherein, upon sensing the innermost conductive pad among the plurality of conductive pads through the first sensor in the first sensing step, the sensor IC sets the other conductive pads and the shielding unit to operate in any one of ground (GND), shielding, and static voltage modes to reduce sensitivity changes caused by external noise and touch.

16. The pressure touch sensing method according to claim 11, wherein, upon sensing the outermost conductive pad among the plurality of conductive pads through the second sensor in the second sensing step, the sensor IC sets a conductive pad disposed under the outermost conductive pad to operate in any one of shielding, ground (GND) and disconnection modes and sets the shielding unit to operate in any one of ground (GND), shielding, and static voltage modes to improve noise characteristics and sensitivity with respect to capacitance changes caused by external touch and proximity.

17. The pressure touch sensing method according to claim 11, wherein, after pressure sensing, the sensor IC senses the innermost conductive pad through the first sensor to detect a capacitance change due to an environmental change, and sets the other conductive pads and the shielding unit to operate in any one of ground (GND), shielding, and static voltage modes to reduce sensitivity changes caused by external noise and touch.

18. The pressure touch sensing method according to claim 11, wherein
the outermost conductive pad is disposed in a smaller area than other conductive pads adjacent thereto, and
the shielding unit is formed to enclose the outermost conductive pad disposed in a smaller area.

19. The pressure touch sensing method according to claim 11, wherein, upon sensing a capacitance change due to external touch and proximity through the second sensor in the second sensing step, the converter of the sensor IC outputs in-phase waveforms to the shielding unit and a conductive pad other than the conductive pad sensed through the second sensor to prevent occurrence of a potential difference and malfunction due to conductive foreign materials.

20. The pressure touch sensing method according to claim 11, wherein, upon sensing the outermost conductive pad among the plurality of conductive pads through the second sensor in the second sensing step, the sensor IC sets the shielding unit to operate in any one of ground (GND), shielding, and static voltage modes to improve noise characteristics and sensitivity with respect to
capacitance changes caused by external touch and proximity.
